(19) United States
(12) Patent Application Publication
(10) Pub. No.: US 2026/0260376 A1
(43) Pub. Date: Sep. 3, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Kazufumi ONUMA, Kanagawa (JP)

(21) Appl. No.: 19/531,772

(22) Filed: Feb. 6, 2026

(30) Foreign Application Priority Data
Feb. 28, 2025 (JP) 2025-031409

(51) Int. Cl. G06T 7/73; G06T 7/55; G06T 7/62; G06T 15/20

(52) U.S. Cl. CPC G06T 7/73; G06T 7/55; G06T 7/62; G06T 15/205; G06T 2207/10016; G06T 2207/20021; G06T 2207/30196; G06T 2207/30221

(57) ABSTRACT

The estimation accuracy of a position of an object as a target is improved. An image processing apparatus according to the present disclosure is configured to: obtain shape data indicating a three-dimensional shape of each object existing in a space as a target; estimate, for each shape data, the number of three-dimensional shape corresponding to the object as the target included in the three-dimensional shape indicated by the shape data; separate the three-dimensional shape corresponding to the object as the target, which is included in the three-dimensional shape indicated by the shape data, based on the estimated number and a height image indicating a height of a three-dimensional shape obtained by projecting the three-dimensional shape indicated by the shape data on a horizontal plane from the above; and specify a position of the separated three-dimensional shape corresponding to the object as the target.

### BACKGROUND

### Field of the Technology

The present disclosure relates to an estimation technique of a position of an object.

### Description of the Related Art

There is a technique of generating an image corresponding to a view from an arbitrary virtual viewpoint (hereinafter, referred to as “virtual viewpoint”) designated by a user and the like based on multiple image-captured images (hereinafter, referred to as “multi-viewpoint image”) obtained by image capturing by multiple image capturing apparatuses. Japanese Patent Laid-Open No. 2024-55093 (hereinafter, referred to as “PTL 1”) discloses the following technique as preprocessing for generating the image concerned (hereinafter, referred to as “virtual viewpoint image”). Specifically, in each image-captured image forming the multi-viewpoint image, a region that has great temporal change is extracted as a foreground region, and a region that has small change is extracted as a background region. Subsequently, based on the extracted foreground region, a three-dimensional shape corresponding to an object existing in a space as an image capturing target of the multiple image capturing apparatuses is estimated. Subsequently, based on the estimated three-dimensional shape, the position of the object concerned is estimated.

### SUMMARY

In the technique disclosed in PTL 1, a three-dimensional shape near a floor surface is extracted under the assumption that the image capturing is performed in a state in which the floor surface is in a stable state like a studio and the like. However, in sporting competition such as a baseball game, a state of a field surface is changed over time depending on play. In the above-described case, in the image-captured image, a region of a representation in a changed portion on the field surface may be detected as the foreground region, and a three-dimensional shape corresponding to a non-existent object (hereinafter, referred to as “false shape”) may be estimated. Accordingly, in a case where the state of the field surface as the image capturing target is changed over time, the technique disclosed in PTL 1 has a problem that the estimation accuracy of the position of an object as a target is reduced due to the estimated false shape.

An image processing apparatus according to the present disclosure includes one or more hardware processors; and one or more memories storing one or more programs configured to be executed by the one or more hardware processors, the one or more programs including instructions for: obtaining shape data indicating a three-dimensional shape of each object existing in a space as a target; estimating, for each shape data, the number of three-dimensional shape corresponding to an object as a target included in the three-dimensional shape indicated by the shape data; separating the three-dimensional shape corresponding to the object as the target, which is included in the three-dimensional shape indicated by the shape data, based on the estimated number and a height image indicating a height of a three-dimensional shape obtained by projecting the three-dimensional shape indicated by the shape data on a horizontal plane from the above; and specifying a position of the separated three-dimensional shape corresponding to the object as the target.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a configuration of an image processing system according to a first embodiment;

FIG. 2 is a block diagram illustrating an example of a logical configuration of an image processing apparatus according to the first embodiment;

FIG. 3 is a block diagram illustrating an example of a hardware configuration of the image processing apparatus according to the first embodiment;

FIG. 4 is a flowchart illustrating an example of a processing flow of the image processing apparatus according to the first embodiment;

FIG. 5 is a flowchart illustrating an example of a flow of specification processing by a specification unit according to the first embodiment;

FIGS. 6A to 6D are diagrams describing an example of processing by the specification unit according to the first embodiment;

FIG. 7 is a flowchart illustrating an example of a flow of separation processing and the specification processing by the specification unit according to the first embodiment;

FIG. 8 is a diagram illustrating an example of a selection screen to accept an instruction to select an identifier according to the first embodiment;

FIGS. 9A and 9B are diagrams illustrating an example of automatic maneuvering of a virtual viewpoint according to the first embodiment; and

FIG. 10 is a diagram illustrating an example of a display image according to the first embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### (Configuration of Image Processing System)

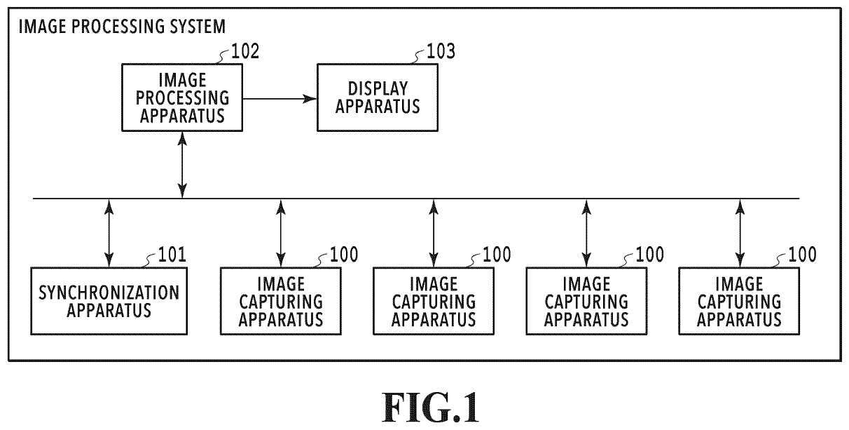

FIG. 1 is a block diagram illustrating an example of a configuration of an image processing system according to a first embodiment. The image processing system includes multiple image capturing apparatuses 100, a synchronization apparatus 101, an image processing apparatus 102, and a display apparatus 103. Note that, the image processing system may include a single image processing apparatus 102 or may include multiple image processing apparatuses 102. In the following descriptions, it is described that the image processing system includes a single image processing apparatus 102.

The multiple image capturing apparatuses 100 are formed of digital video cameras and the like and perform image capturing of a space as an image capturing target (hereinafter, referred to as “image capturing region”) from directions different from each other in synchronization with each other. Specifically, each of the multiple image capturing apparatuses 100 receives a synchronization signal from the synchronization apparatus 101 and performs image capturing based on the received synchronization signal. Data of multiple image-captured images (multi-viewpoint image) obtained by the synchronized image capturing by the multiple image capturing apparatuses 100 is outputted to the image processing apparatus 102. Note that, for example, the multiple image capturing apparatuses 100 are installed to surround the image capturing region so as to be able to perform image capturing of an object existing in the image capturing region (hereinafter, simply referred to as “object”) from multiple directions.

The image processing apparatus 102 obtains the data of the multi-viewpoint image outputted from the multiple image capturing apparatuses 100, generates a virtual viewpoint image corresponding to a view from an arbitrary virtual viewpoint, and outputs data of a display image including the generated virtual viewpoint image to the display apparatus 103. The display apparatus 103 is formed of a liquid crystal display and the like to obtain the data of the display image outputted from the image processing apparatus 102 and display the display image concerned.

### (Configuration of Image Processing Apparatus)

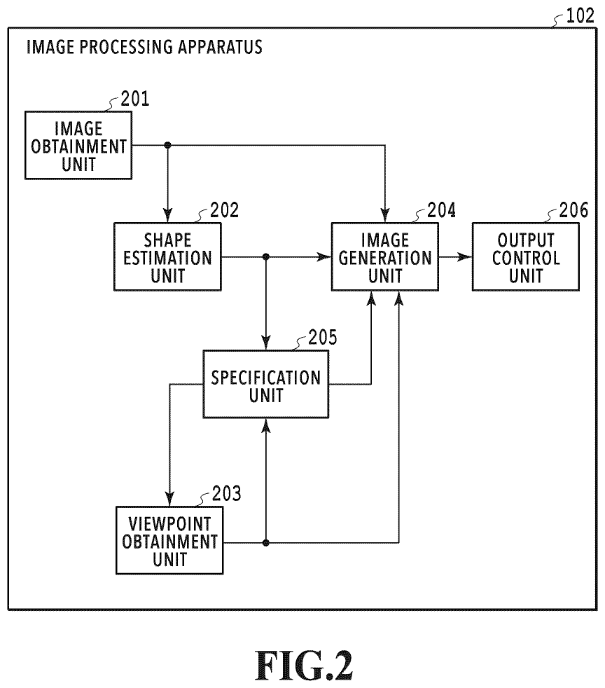

FIG. 2 is a block diagram illustrating an example of a logical configuration of the image processing apparatus 102 according to the first embodiment. The image processing apparatus 102 includes an image obtainment unit 201, a shape estimation unit 202, a viewpoint obtainment unit 203, an image generation unit 204, a specification unit 205, and an output control unit 206 as the logical configuration. Processing of each unit included in the image processing apparatus 102 as the logical configuration is implemented by processing hardware built in the image processing apparatus 102 such as an application specific integrated circuit (ASIC). The processing concerned may be implemented by software using a computation processing device built in the image processing apparatus 102 such as a central processor unit (CPU) or a graphics processor unit (GPU) and a memory. Details of the processing of each unit included in the image processing apparatus 102 as the logical configuration are described later.

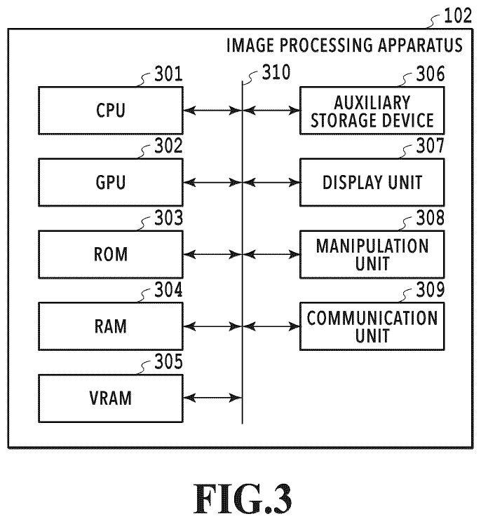

A hardware configuration of the image processing apparatus 102 in a case where the processing of each unit included in the image processing apparatus 102 as the logical configuration is implemented by executing the software is described with reference to FIG. 3. FIG. 3 is a block diagram illustrating an example of the hardware configuration of the image processing apparatus 102 according to the first embodiment. The image processing apparatus 102 is formed of a computer, and the computer concerned includes a CPU 301, a GPU 302, a ROM 303, a RAM 304, a VRAM 305, and an auxiliary storage device 306 as a hardware configuration. Additionally, the computer concerned includes a display unit 307, a manipulation unit 308, a communication unit 309, and a bus 310 as a hardware configuration.

The CPU 301 controls the computer concerned by using a program and data stored in the ROM 303, the auxiliary storage device 306, or the like to function as each unit included in the image processing apparatus 102 as the logical configuration. The ROM 303 stores a program, various data, and the like that do not need to be changed. The auxiliary storage device 306 is formed of hard disk drive or the like, for example, and stores a program and various types of data such as image data or sound data. The RAM 304 operates as a working area of the CPU 301 and temporarily stores the program and the data supplied from the ROM 303 or the auxiliary storage device 306 or data and the like supplied from the outside by way of the communication unit 309.

The GPU 302 controls the computer concerned in cooperation with the CPU 301 by using the program or the data stored in the ROM 303, the auxiliary storage device 306, or the like to function as each unit included in the image processing apparatus 102 as the logical configuration. The VRAM 305 is a memory for graphics processing that operates as a working area of the GPU 302 and temporarily stores the program and the data supplied from the ROM 303, the auxiliary storage device 306, or the like. Note that, the image processing apparatus 102 may include one or more pieces of dedicated processing hardware different from the CPU 301 and the GPU 302, and the processing hardware may execute at least a part of the processing performed by the CPU 301 or the GPU 302. An example of the dedicated processing hardware includes an ASIC, a field programmable gate array (FPGA), a digital signal processor (DSP), and the like.

The display unit 307 is formed of a liquid crystal display, a light-emitting diode (LED), or the like. The display unit 307 displays a graphical user interface (GUI) to allow the user to manipulate the image processing apparatus 102, a GUI to allow the user to browse a state of the image processing apparatus 102, or the like. The manipulation unit 308 is formed of a keyboard, a mouse, a touch panel, or the like that receives the manipulation by the user and inputs various instructions corresponding to the manipulation concerned to the CPU 301. The CPU 301 operates also as a display control unit that controls the display unit 307 and a manipulation control unit that controls the manipulation unit 308.

The communication unit 309 is used for communication of the image processing apparatus 102 with an external apparatus. For example, in a case of wired connection of the image processing apparatus 102 with an external apparatus, a cable for communication is connected to the communication unit 309. In a case where the image processing apparatus 102 has a function to establish wireless communication with an external apparatus, the communication unit 309 includes an antenna. The bus 310 communicably connects the above-described hardware configurations included in the image processing apparatus 102 and transfers information. Hereinafter, it is described that the display unit 307 and the manipulation unit 308 exist inside the image processing apparatus 102; however, at least one of the display unit 307 and the manipulation unit 308 may exist as a different apparatus outside the image processing apparatus 102.

The image obtainment unit 201 obtains the data of the multi-viewpoint image outputted from the multiple image capturing apparatuses 100. Additionally, the image obtainment unit 201 obtains a camera parameter in a case where each of the multiple image capturing apparatuses 100 performs image capturing of each image-captured image forming the multi-viewpoint image. The camera parameter includes an external parameter related to the position and the orientation of the image capturing apparatus that performs image capturing of the image-captured image and an internal parameter related to a focal length, a principal point, a resolution, and the like. Note that, the camera parameter may be stored in advance in the auxiliary storage device 306 or the like or may be outputted from each image capturing apparatus 100. The data of the multi-viewpoint image obtained by the image obtainment unit 201 and the camera parameter corresponding to each image-captured image obtained by image capturing of each image capturing apparatus or multiple image capturing apparatuses are outputted and stored into the auxiliary storage device 306 and the like.

The shape estimation unit 202 estimates the three-dimensional shape of the object by using the multi-viewpoint image obtained by the image obtainment unit 201 and the camera parameter corresponding to each image-captured image forming the multi-viewpoint image. Specifically, for example, first, the shape estimation unit 202 extracts a region including the representation of the object in each image-captured image as a silhouette by performing foreground-background separation of each image-captured image. A method of the foreground-background separation is publicly known; for this reason, the description is omitted. Note that, in a case where the foreground-background separation is performed by a background difference method and the like, the data of the background image corresponding to each image-captured image is stored in advance in the RAM 304, the auxiliary storage device 306, or the like. Subsequently, the shape estimation unit 202 estimates the three-dimensional shape of the object by a method such as visual hull by using the camera parameter of each image capturing apparatus 100 obtained by the image obtainment unit 201. The visual hull is publicly known; for this reason, the description is omitted. The data related to the three-dimensional shape of the object estimated by the shape estimation unit 202 is outputted and stored into the auxiliary storage device 306 and the like. In this case, the object is a natural person, items treated by the natural person, or the like that is a target of estimation of the three-dimensional shape.

The specification unit 205 specifies the position of the natural person existing in the image capturing region by using the three-dimensional shape estimated by the shape estimation unit 202. Additionally, the specification unit 205 generates information related to the position of each natural person that changes over time (hereinafter, referred to as “tracking information”) by performing tracking for each natural person based on the specified position of the natural person. The tracking information generated by the specification unit 205 is outputted and stored into the auxiliary storage device 306 and the like. In a case of a state in which the natural persons are distant from each other at the time point of image capturing of the multi-viewpoint image used for estimation of the three-dimensional shape by the shape estimation unit 202, an individual three-dimensional shape may be estimated for each natural person. However, in a case of a state in which the natural persons are in contact with each other or a state of being close to each other, there is a possibility that the three-dimensional shapes of the multiple natural persons are estimated as a single three-dimensional shape. Therefore, the specification unit 205 performs the following processing, taking into consideration the possibility that the three-dimensional shapes of the multiple natural persons are estimated as a single three-dimensional shape. Specifically, in the three-dimensional shape that may include the three-dimensional shapes corresponding to the multiple natural persons, the specification unit 205 separates the corresponding three-dimensional shapes for each natural person and specifies the position of each three-dimensional shape corresponding to the natural person.

The viewpoint obtainment unit 203 obtains information related to the virtual viewpoint (hereinafter, referred to as “virtual viewpoint information”). The virtual viewpoint information includes information such as information related to the position of the virtual viewpoint and a line-of-sight direction in the virtual viewpoint that correspond to the external parameter of the image capturing apparatus, information related to the focal length, the principal point, and the like that correspond to the internal parameter, and information related to a timecode of the generated virtual viewpoint image. Hereinafter, the line-of-sight direction in the virtual viewpoint is referred to as “orientation of the virtual viewpoint.” Specifically, for example, the user inputs the position and the orientation of the virtual viewpoint, the focal length and the principal point of the virtual viewpoint, the timecode of the generated virtual viewpoint image, and the like by manipulating the manipulation unit 308. The viewpoint obtainment unit 203 obtains the virtual viewpoint information by receiving a signal corresponding to the input concerned from the manipulation unit 308. Additionally, for example, the viewpoint obtainment unit 203 may obtain the information related to the virtual viewpoint concerned by, for example, determining the position and the orientation of the virtual viewpoint that automatically track a predetermined object (natural person) by using the tracking information generated by the specification unit 205.

The image generation unit 204 generates the virtual viewpoint image. Specifically, first, based on the timecode included in the virtual viewpoint information obtained by the viewpoint obtainment unit 203, the image generation unit 204 obtains a material required to generate the virtual viewpoint image corresponding to the timecode concerned by reading out from the auxiliary storage device 306 and the like. In this case, the material required to generate the virtual viewpoint image is, for example, the data related to the three-dimensional shape of the object, the data of the image-captured image, and the camera parameter, and data such as a background model and a texture image of the background that are corresponding to the timecode concerned. Subsequently, the image generation unit 204 generates the virtual viewpoint image corresponding to a view from the virtual viewpoint indicated by the virtual viewpoint information by using the obtained material concerned. A method of generating the virtual viewpoint image corresponding to an arbitrary virtual viewpoint by using the data related to the three-dimensional shape of the object, the data of the image-captured image, and the camera parameter, and the data such as the background model and the texture image of the background is publicly known; for this reason, the description is omitted. The data of the virtual viewpoint image generated by the image generation unit 204 is outputted to the output control unit 206.

The output control unit 206 generates the display image including the virtual viewpoint image generated by the image generation unit 204, outputs data of the generated display image to the display apparatus 103, and displays the display image concerned on the display apparatus 103.

### (Operation of Image Processing Apparatus)

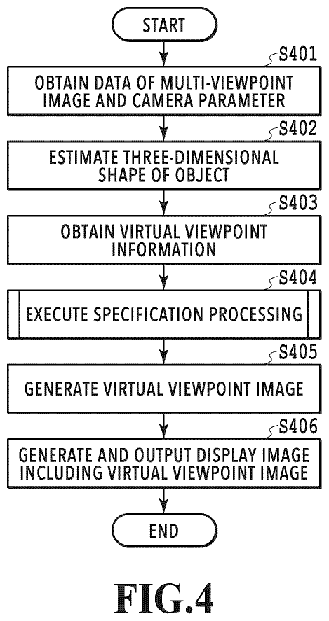

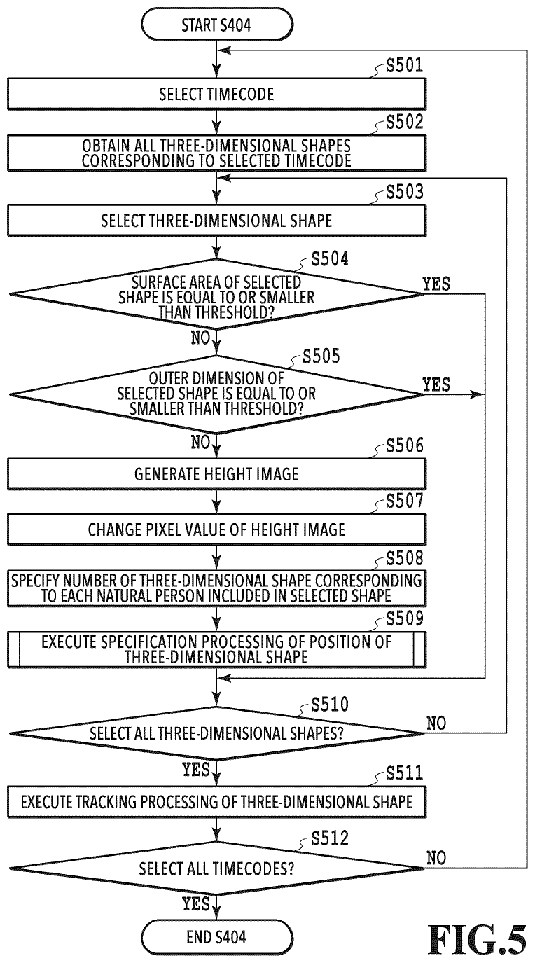

An example of the operation of the image processing apparatus 102 is described with reference to FIGS. 4 and 5. FIG. 4 is a flowchart illustrating an example of a processing flow of the image processing apparatus 102 according to the first embodiment. Note that, a sign “S” means a step in the following descriptions. First, in S401, the image obtainment unit 201 obtains the multi-viewpoint image and the camera parameter corresponding to each image-captured image forming the multi-viewpoint image. The data of the multi-viewpoint image and the camera parameter obtained in S401 are stored in the auxiliary storage device 306 and the like. Next, in S402, the shape estimation unit 202 estimates the three-dimensional shape of the object by using the multi-viewpoint image and the camera parameter corresponding to each image-captured image obtained in S401. The data of the three-dimensional shape estimated in S402 is stored into the auxiliary storage device 306 and the like. Next, in S403, the viewpoint obtainment unit 203 obtains the virtual viewpoint information. In S404, the specification unit 205 executes specification processing described later. Details of the processing in and after S405 are described later.

### (Specification Processing by Specification Unit)

FIG. 5 is a flowchart illustrating an example of a flow of the specification processing by the specification unit 205 according to the first embodiment, that is, the specification processing in S404 illustrated in FIG. 4. Note that, in the present embodiment, as an example, it is described that the image capturing target is baseball game, and the specification unit 205 performs specification of the position of each natural person (hereinafter, referred to as “player”) playing the baseball game and generation of tracking information related to each player. Particularly, in the present embodiment, as an example, a case of a result of the estimation by the shape estimation unit 202 in which the three-dimensional shape corresponding to each of three players and the false shape estimated according to a temporal change of a state of the field surface are included in a single three-dimensional shape is described.

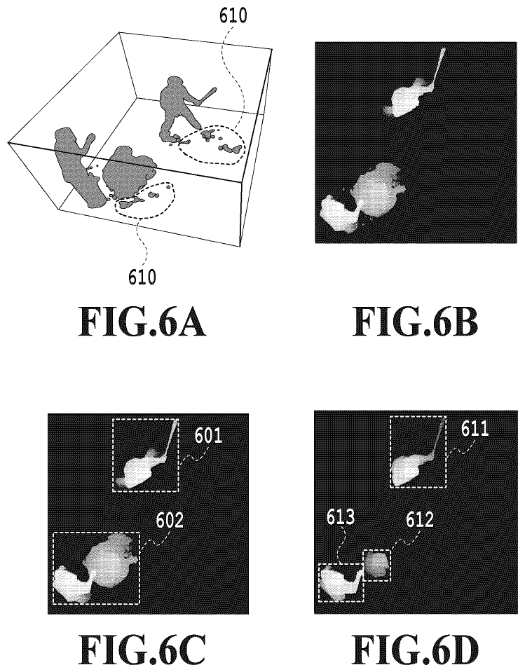

FIGS. 6A to 6D are diagrams describing an example of processing by the specification unit 205 according to the first embodiment. Specifically, FIG. 6A illustrates the three-dimensional shape corresponding to each of the three players and a false shape 610 that are obtained by the estimation by the shape estimation unit 202. FIGS. 6B to 6D are described later.

In the processing in S404, first, in S501, the specification unit 205 selects an arbitrary timecode from a period of time indicated by the timecode included in the virtual viewpoint information obtained in S403 (hereinafter, referred to as “period of time as the processing target”). Note that, the specification unit 205 sequentially selects one of the one or more timecodes included in the period of time as the processing target in S501 by performing repeated processing described later. Hereinafter, it is described that, in the repeated processing described later, the specification unit 205 selects the timecode closest to the start of the period of time as the processing target from the not-selected timecodes out of all the timecodes included in the period of time as the processing target. Next, in S502, the specification unit 205 obtains all the three-dimensional shapes corresponding to the timecode selected in S501 (hereinafter, referred to as “selected timecode”). Specifically, the specification unit 205 obtains the data of all the three-dimensional shapes corresponding to the selected timecode by reading out from the auxiliary storage device 306 and the like.

Next, in S503, the specification unit 205 selects an arbitrary three-dimensional shape from the three-dimensional shapes obtained in S502. Next, in S504 and S505, based on the three-dimensional shape selected in S503 (hereinafter, referred to as “selected shape”), the specification unit 205 judges whether the selected shape is the three-dimensional shape corresponding to the natural person (player) as the object as a target. Specifically, the specification unit 205 judges whether the size of the selected shape, which is selected in S503, is equal to or smaller than a predetermined threshold.

In this case, the size of the three-dimensional shape is at least one of a volume, a surface area, and an outer shape dimension of the three-dimensional shape. For example, in a case where the data of the three-dimensional shape is expressed by dense point cloud, the specification unit 205 may obtain an approximate volume of the object based on the number of points included in the point cloud. Additionally, in a case where the data of the three-dimensional shape is expressed by the point cloud representing a surface shape of the object, the specification unit 205 may obtain an approximate surface area of the object based on the number of the points included in the point cloud of the three-dimensional shape. As for the outer shape dimension, a value of at least one of a width, a depth, and a height of the three-dimensional shape may be used.

As the above-described threshold, under the assumption that a surface area of a general adult is about 1.6 m² (square meters), the threshold of the surface area may be 1.2 square meters that corresponds to about 70 percent of 1.6 m², taking into consideration a change in the surface area due to an effect of body build, clothes, orientation, and so on, for example. Additionally, under the assumption that a volume of a general adult is about 60,000 cm³ (cubic centimeters), for example, the threshold of the volume may be 42,000 cm³ that corresponds to about 70 percent of 60,000 cm³, taking into consideration the change concerned. Moreover, the threshold of the width, the depth, or the height may be 40 cm (centimeters), taking into consideration a body height, a shoulder width, and the like of a general adult. With the above-described threshold, even in a state in which the natural person is in a squatting position, the outer shape dimension of the natural person is not fitted within the threshold concerned in a usual case.

Hereinafter, it is described that the data of the three-dimensional shape is expressed by the point cloud representing the surface shape of the object. In this case, for example, the specification unit 205 judges in S504 whether the surface area of the selected shape is equal to or smaller than the predetermined threshold and judges in S505 whether the outer shape dimension of the selected shape is equal to or smaller than the predetermined threshold. If it is judged that the size is equal to or smaller than the threshold in S504 or S505, the specification unit 205 judges that the selected shape is not the three-dimensional shape corresponding to the natural person and executes processing in S510 described later. If it is judged that the size is not equal to or smaller than the threshold in S504 and S505, the specification unit 205 judges that the selected shape is the three-dimensional shape including the three-dimensional shape corresponding to one or more natural persons and executes processing in S506 described later.

In S506, the specification unit 205 generates an image indicating a depth in a case of viewing the selected shape, which is selected in S503, from the above, that is, a height from the field surface (hereinafter, referred to as “height image”). FIGS. 6B to 6D illustrate an example of the height image. Specifically, the height image illustrated in FIG. 6B corresponds to a case of viewing the three-dimensional shape illustrated in FIG. 6A from the above. FIGS. 6C and 6D are described later. Note that, as an example, the height image illustrated in FIGS. 6B to 6D expresses a portion at a low height, that is, a portion with a great value of distance from the above with a low brightness, and expresses a portion at a high height, that is, a portion with a small value of distance from the above with a high brightness.

Next, in S507, the specification unit 205 changes a value of a pixel corresponding to a pixel with a low brightness in the height image to a pixel value corresponding to black color by performing contraction processing and the like on the height image generated in S506. With the above-described processing, a pixel value of a region corresponding to the three-dimensional shape (false shape) near the field surface that is detected erroneously as the object due to a temporal change of the field floor surface in the height image may be removed. Additionally, likewise, a pixel value of a region corresponding to a fine three-dimensional shape of noise and the like generated by other processing such as the foreground extraction processing and the shape estimation processing may be removed.

Next, in S508, based on the height image after change that is obtained by the changing processing in S507 (hereinafter, referred to as “changed height image”), the specification unit 205 specifies the number of the three-dimensional shape corresponding to each natural person included in the selected shape. Specifically, for example, first, the specification unit 205 performs binarization processing on the changed height image. Subsequently, based on an area of a region formed of a pixel other than black color in the changed height image after binarization (hereinafter, referred to as “effective region”), the specification unit 205 specifies the number of the three-dimensional shape corresponding to the natural person included as the representation of the three-dimensional shape in the changed height image obtained in S507. Specifically, since a projection area from immediately above the natural person is about 0.5 m² (square meters), the specification unit 205 divides the number of the pixels included in the effective region by the pixel number corresponding to 0.5 m² and thus specifies the number of the three-dimensional shape corresponding to the natural person included as the representation of the three-dimensional shape in the height image. For example, in a case where a value of quotient is around 3, the specification unit 205 specifies that the representations of the three-dimensional shapes corresponding to three natural persons are included in the changed height image.

Next, in S509, based on the changed height image obtained in S507 and the number of the three-dimensional shape corresponding to the natural person specified in S508, the specification unit 205 executes separation processing of the three-dimensional shape corresponding to the natural person and specification processing of the position of the three-dimensional shape after separation. With the separation processing and the specification processing in S509, even in a case where the selected shape includes the three-dimensional shapes corresponding to multiple natural persons, the position of the three-dimensional shape corresponding to each natural person may be specified. Details of the separation processing and the specification processing in S509 are described later.

Next, in S510, the specification unit 205 judges whether all the three-dimensional shapes obtained in S502 are selected as the selected shapes in S503. If it is judged that all the three-dimensional shapes are selected in S510, the specification unit 205 executes processing in S511 described later. Otherwise, the specification unit 205 returns to the processing in S503 and repeatedly executes the processing from S503 to S510 until it is judged that all the three-dimensional shapes are selected in S510. Note that, in the processing in S503 in the above-described repeated processing, the specification unit 205 selects an arbitrary three-dimensional shape from one or more three-dimensional shapes that are not selected thus far as the selected shape. With the repeated processing from S503 to S510, the position of the three-dimensional shape corresponding to each of all the natural persons existing in the image capturing region at the selected timecode is specified.

In S511, the specification unit 205 executes tracking processing of the three-dimensional shape corresponding to each natural person. Specifically, the specification unit 205 performs the tracking processing by comparing the positions of the three-dimensional shapes corresponding to the respective natural persons, which are specified in S510, at the selected timecode and a timecode that is selected in the repeated processing and different from the selected timecode. Specifically, in a case where there is still only one timecode selected in S510, the specification unit 205 executes the following processing. For example, in this case, the specification unit 205 associates the information indicating the position of the three-dimensional shape corresponding to each natural person at the selected timecode, which is selected in S501, with the selected timecode and an identifier such as a serial number that may uniquely identify the three-dimensional shape. Subsequently, the specification unit 205 stores the information associated with each other into the auxiliary storage device 306 and the like as the tracking information.

In contrast, in a case where multiple timecodes are selected in S501 by the repeated processing, the specification unit 205 executes the following processing. For example, in this case, the specification unit 205 compares the positions of the three-dimensional shapes corresponding to each natural person at the selected timecode and a timecode immediately before the selected timecode. Subsequently, the specification unit 205 specifies the three-dimensional shape corresponding to the natural person at the concerned timecode that is immediately before the selected timecode, the three-dimensional shape being at the position closest to each three-dimensional shape corresponding to the natural person at the selected timecode. Subsequently, the specification unit 205 associates the selected timecode and an identifier that is the same as the identifier associated with the position of the three-dimensional shape corresponding to the natural person at the concerned specified timecode, which is immediately before the selected timecode, with the information indicating the position of each three-dimensional shape corresponding to the natural person at the selected timecode. Subsequently, the specification unit 205 stores the information associated with each other into the auxiliary storage device 306 and the like as the tracking information.

After S511, in S512, the specification unit 205 judges whether all the timecodes of the period of time as the processing target are selected as the selected timecode in S501. If it is judged in S512 that at least a part of all the timecodes is not selected as the selected timecode, the specification unit 205 returns to the processing in S501. In this case, the specification unit 205 repeatedly executes the processing from S501 to S512 until it is judged in S512 that all the timecodes are selected as the selected timecode. If it is judged in S512 that all the timecodes are selected as the selected timecode, the specification unit 205 ends the processing in the flowchart illustrated in FIG. 5, that is, the processing in S404.

Note that, although it is described that the image-captured images corresponding to all the timecodes of the period of time as the processing target are stored in advance in the auxiliary storage device 306 and the like in the present embodiment, a scope of application of the technique of the present disclosure is not limited to the above-described case. For example, the image processing apparatus 102 may obtain the data of the image-captured image obtained by image capturing by the image capturing apparatus 100 every time the data concerned is outputted from the image capturing apparatus 100, and sequentially, the processing in the above-described flowchart may be repeatedly executed based on the data concerned. In this case, it is desirable for the specification unit 205 to execute the processing in the flowchart illustrated in FIG. 5, that is, the processing in S404 illustrated in FIG. 4 after waiting for completion of the processing in S403 based on the multi-viewpoint image corresponding to the latest timecode that is newly obtained.

### (Separation Processing and Specification Processing by Specification Unit)

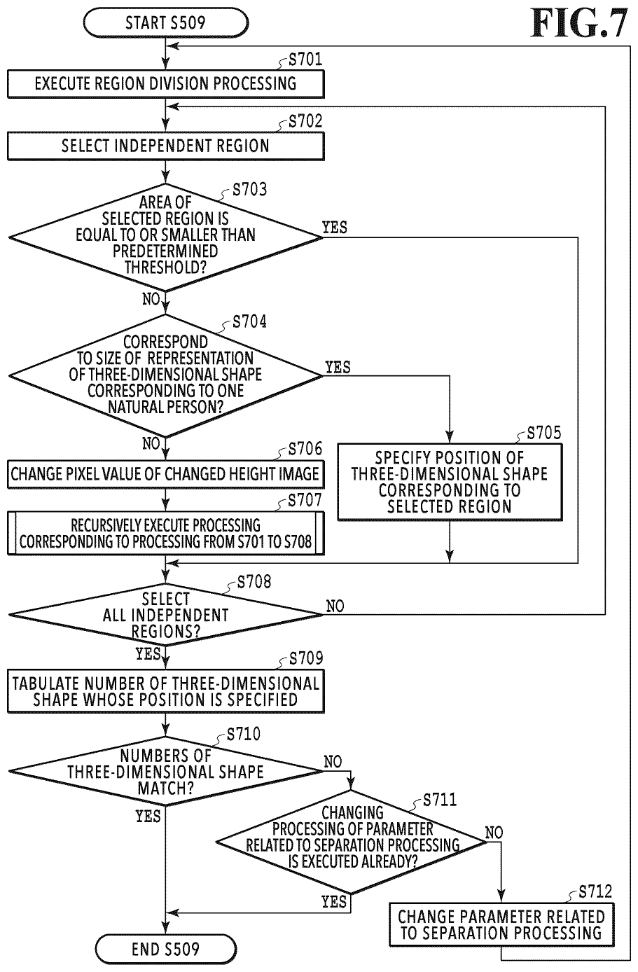

FIG. 7 is a flowchart illustrating an example of a flow of the separation processing and the specification processing by the specification unit 205 according to the first embodiment, that is, the separation processing and the specification processing in S509 illustrated in FIG. 5. In S509, first, in S701, the specification unit 205 executes region division processing (also referred to as “segmentation”) on the effective region in the changed height image after binarization that is obtained by the binarization processing in S508.

FIG. 6C illustrates an example of a segmentation result of the changed height image obtained by the binarization processing in S508. In the example illustrated in FIG. 6C, a region 601 is a region including only the representation of the three-dimensional shape corresponding to one natural person. However, a region 602 is a region including the representations of the three-dimensional shapes corresponding to two natural persons.

After S701, in S702, the specification unit 205 selects an arbitrary independent region from one or more segments obtained as the segmentation result in S701 (also referred to as “independent region”). Next, in S703, the specification unit 205 judges whether an area of the independent region selected in S702 (hereinafter, referred to as “selected region”) is equal to or smaller than a predetermined threshold. In this case, the threshold concerned is, for example, at least 0.3 m² as an area that may include the representation of the three-dimensional shape corresponding to one natural person.

If it is judged that the area is equal to or smaller than the threshold in S703, it is judged that the size of the selected region is a size that may not include the representation of the three-dimensional shape corresponding to the natural person, and the specification unit 205 executes processing in S708 described later. Otherwise, in S704, the specification unit 205 judges whether the size of the selected region corresponds to the size of the representation of the three-dimensional shape corresponding to one natural person. If it is judged in S704 that the size of the selected region corresponds to the size of the representation of the three-dimensional shape corresponding to one natural person, it is judged that the selected region is a region including the representation of the three-dimensional shape corresponding to one natural person, and the specification unit 205 executes processing in S705 described later. Otherwise, it is judged that the selected region is a region including the representations of the three-dimensional shapes corresponding to two or more natural persons, and the specification unit 205 executes processing in S706 described later.

In S705, the specification unit 205 specifies the position of the three-dimensional shape corresponding to the selected region. Specifically, for example, as the position of the three-dimensional shape concerned, the specification unit 205 specifies an arbitrary position of the center of gravity or the like of the three-dimensional shape concerned. The specification method of the position of the three-dimensional shape corresponding to the selected region performed by the specification unit 205 is not limited thereto and, for example, the position concerned may be specified by the following method. For example, first, the specification unit 205 specifies a predetermined position of the center of gravity or the like of the selected region on a plane of the changed height image as the position on a horizontal plane in the three-dimensional shape corresponding to the selected region. Subsequently, the specification unit 205 specifies the position of the three-dimensional shape corresponding to the selected region in a vertical direction by calculating the height of the three-dimensional shape concerned based on the pixel value of the selected region in the changed height image. After S705, the specification unit 205 executes the processing in S708 described later.

In S706, the specification unit 205 changes the value of the pixel (pixel value) with a low brightness in the changed height image to the pixel value corresponding to black color. After S706, in S707, the specification unit 205 recursively executes the processing corresponding to the processing from S701 to S708 described later by using the image obtained by the changing processing in S706 as the changed height image. With the above-described recursive processing, the region including the representations of the three-dimensional shapes corresponding to two or more natural persons may be separated into multiple regions each including the representation of the three-dimensional shape corresponding to one natural person, and the position of the three-dimensional shape corresponding to each natural person may be specified. After S707, the specification unit 205 executes the processing in S708 described later.

FIG. 6D illustrates an example of the changed height image that is obtained by the recursive region division processing. Specifically, the changed height image illustrated in FIG. 6D illustrates three segments (independent regions 611 to 613) obtained by the recursive region division processing performed on the region 602 illustrated in FIG. 6C. Note that, even in a case where the recursive processing is performed, separation of regions that obtains the region including the representation of the three-dimensional shape corresponding to one natural person may not be performed properly. Therefore, an upper limit of the number of times of execution of the recursive processing may be set in advance, and in a case where the number of times of execution concerned reaches the upper limit, the specification unit 205 may cancel the subsequent recursive processing and specify the position of the three-dimensional shape corresponding to the independent region as the processing target at that time point.

In S708, the specification unit 205 judges whether all the independent regions obtained as a result of segmentation in S702 are selected. If it is judged in S708 that at least a part of the independent regions is not selected, the specification unit 205 returns to the processing in S702 and repeatedly executes the processing from S702 to S708 until it is judged in S708 that all the independent regions are selected. If it is judged in S708 that all the independent regions are selected, in S709, the specification unit 205 tabulates the number of the three-dimensional shape whose position is specified in S705 and that in S705 in the recursive processing.

After S709, in S710, the specification unit 205 judges whether the number of the three-dimensional shape tabulated in S709 and the number of the three-dimensional shape corresponding to each natural person specified in S508 match. If it is judged in S710 that the numbers match, the specification unit 205 ends the processing in the flowchart illustrated in FIG. 7, that is, the processing in S509 illustrated in FIG. 5. Otherwise, since there may be a case where proper separation processing is not performed, the specification unit 205 may change the parameter related to the separation processing and execute again the processing from S701 to S710.

Specifically, for example, in this case, first, in S711, the specification unit 205 judges whether changing processing of the parameter related to the separation processing, which is described later, is already executed. If it is judged in S711 that the changing processing of the parameter related to the separation processing is not executed yet, in S712, the specification unit 205 changes the parameter related to the separation processing. Specifically, for example, the specification unit 205 changes a parameter that is related to an interval of changing the pixel with a low brightness to the pixel value corresponding to black color out of the parameters related to the separation processing. After S712, the specification unit 205 discards a processing result from S701 to S710 that is before the parameter related to the separation processing is changed, returns to the processing in S701, and executes the processing in and after S701.

If it is judged in S711 that the changing processing of the parameter related to the separation processing is already executed, the specification unit 205 ends the processing in the flowchart illustrated in FIG. 7, that is, the processing in S509 illustrated in FIG. 5. Note that, in this case, for example, the specification unit 205 executes the processing in and after S510 illustrated in FIG. 5 by using the result of the processing in S705 and that in S705 in the recursive processing obtained as a result of the separation processing using the parameter that is the parameter after change. This is because, in a case where there is an error in the specification of the number of the natural persons specified in S508, or depending on the overlapping between the natural persons, it may be difficult to perform separation. In the present embodiment, an aspect in which changing of the parameter related to the separation processing is performed only once is described; however, the changing concerned may be performed multiple times. Note that, in a case where the changing concerned is performed multiple times, the processing time may be increased, and the processing may not be completed within a predetermined period of time. Therefore, it is desirable to determine the number of times of the changing concerned appropriately by considering the processing performance of the CPU 301 and the like, the period of time concerned, and so on.

Note that, with use of the tracking information generated and stored in S511, the natural person corresponding to the three-dimensional shape corresponding to a specific identifier may be tracked in the image capturing region. Additionally, although the field surface may be changed because, for example, it becomes rough over time depending on the sporting competition, the image processing apparatus 102 according to the present embodiment sequentially deletes the three-dimensional shape near the field surface by the processing of separating the representation of the three-dimensional shape corresponding to the natural person. Therefore, according to the image processing apparatus 102 of the present embodiment, even in a case where the false shape is generated near the field surface due to the temporal change of the field surface, the tracking processing may be performed while eliminating an effect of the false shape.

Additionally, in the comparing processing between the position of the three-dimensional shape at the timecode (selected timecode) as the processing target and the position of the three-dimensional shape at the timecode corresponding to the past time point in the tracking processing, based on a difference between those positions, a movement direction and a movement speed of the three-dimensional shape may be specified. In this case, the specification unit 205 may include information related to the movement direction and the movement speed of each specified three-dimensional shape into the tracking information and stores in the auxiliary storage device 306 and the like.

The processing in and after S405 is described. After S404, in S405, the image generation unit 204 generates the virtual viewpoint image based on the multi-viewpoint image and the camera parameter obtained in S401, the data of the three-dimensional shape estimated in S402, and the virtual viewpoint information obtained in S403. Next, in S406, the output control unit 206 generates the display image including the virtual viewpoint image generated in S405, outputs the data of the generated display image to the display apparatus 103, and displays the display image concerned on the display apparatus 103. After S406, the image processing apparatus 102 ends the processing in the flowchart illustrated in FIG. 4.

In the present embodiment, it is described that the information and the like of the position and the orientation of the virtual viewpoint used in the generation processing of the virtual viewpoint image by the image generation unit 204 are included in advance in the virtual viewpoint information, and the virtual viewpoint information is set by the user manipulating the manipulation unit 308. However, the position and the orientation of the virtual viewpoint are not limited to being set by the user manipulating the manipulation unit 308.

For example, the viewpoint obtainment unit 203 may obtain the information of the position and the orientation of the virtual viewpoint by determining the position and the orientation of the virtual viewpoint based on the tracking information generated in S511. Specifically, for example, first, the viewpoint obtainment unit 203 obtains information that corresponds to the identifier, which is predetermined out of the tracking information corresponding to the period of time as the processing target indicated by the timecode and the like included in the virtual viewpoint information by reading out from the auxiliary storage device 306 and the like. The identifier of the tracking information obtained by the viewpoint obtainment unit 203 is determined by the following method, for example. First, the image generation unit 204 generates the virtual viewpoint image to accept an instruction to select the identifier. The generated virtual viewpoint image concerned is displayed on the display apparatus 103 through the processing by the output control unit 206.

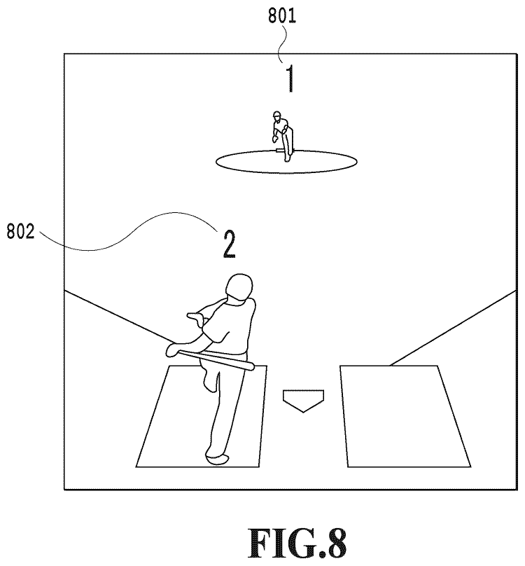

FIG. 8 is a diagram illustrating an example of a selection screen to accept the instruction to select the identifier according to the first embodiment. As an example, in the selection screen illustrated in FIG. 8, representations 801 and 802 of the identifier associated with the three-dimensional shape corresponding to each player are overlapped and displayed near the representation of the player in the virtual viewpoint image. The user confirms contents of the representations 801 and 802 of the identifier and selects the identifier by manipulating the manipulation unit 308. Thus, the image processing apparatus 102 accepts the instruction to select the identifier from the user.

In a case where the instruction to select the identifier from the user is inputted, the viewpoint obtainment unit 203 obtains the tracking information corresponding to the selected identifier. Subsequently, based on the obtained tracking information, the viewpoint obtainment unit 203 determines the position and the orientation of the virtual viewpoint so as to be fitted within an angle of view of the virtual viewpoint image by following the movement and the like of the three-dimensional shape associated with the selected identifier. Hereinafter, it is described that the virtual viewpoint image is generated as a moving image, and at least one of the position and the orientation of the virtual viewpoint is automatically changed based on the tracking information along with the movement and the like of the three-dimensional shape associated with the selected identifier. Hereinafter, the automatic change of at least one of the position and the orientation of the virtual viewpoint based on the tracking information is referred to as “automatic maneuvering of the virtual viewpoint” to be described.

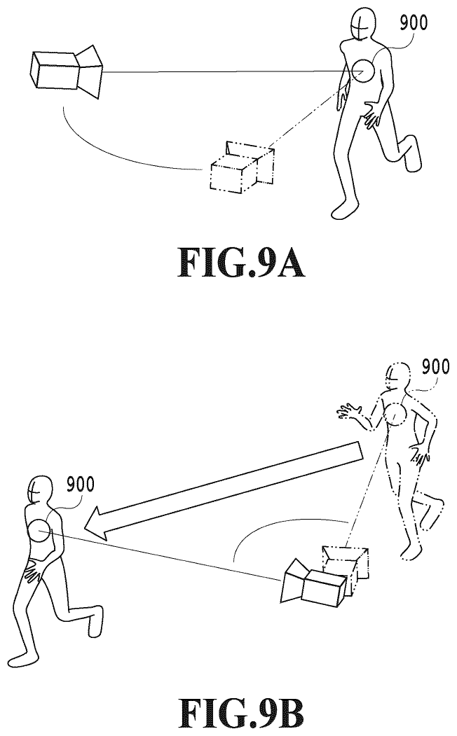

FIGS. 9A and 9B are diagrams illustrating an example of the automatic maneuvering of the virtual viewpoint according to the first embodiment. For example, as illustrated in FIG. 9A, the viewpoint obtainment unit 203 may determine the position and the orientation of the virtual viewpoint such that the virtual viewpoint whirls about a position 900 of the three-dimensional shape corresponding to the natural person indicated by the tracking information as the rotation center of the virtual viewpoint while the line-of-sight direction of the virtual viewpoint is directed to the position 900. Additionally, for example, as illustrated in FIG. 9B, the viewpoint obtainment unit 203 may determine the position and the orientation of the virtual viewpoint such that the position of the virtual viewpoint is fixed while the line-of-sight direction of the virtual viewpoint is directed to the position 900. The method of the automatic maneuvering of the virtual viewpoint illustrated in FIGS. 9A and 9B is merely an example, and the method is not limited thereto.

Additionally, in a case where the automatic maneuvering of the virtual viewpoint based on the tracking information is performed, it is desirable for the viewpoint obtainment unit 203 to perform smoothing processing of the movement of the position and the line-of-sight of the virtual viewpoint with respect to the chronological position of the three-dimensional shape corresponding to the natural person obtained from the tracking information. The reason for performing the smoothing processing is that the position of a three-dimensional shape point specified by the specification unit 205 may include an error by being affected by the orientation of the natural person, the estimation accuracy of the estimation processing of the shape, or the like. Therefore, if smoothing processing is not performed, there may be a slight variation and the like in the position and the orientation of the virtual viewpoint.

Note that, although an aspect in which the representations 801 and 802 of the identifier are overlapped with the virtual viewpoint image and selected by the user is described in the above-described example, it is not necessarily limited thereto. For example, an image that allows the entire field used for the sporting competition to be figured out (hereinafter, “plane viewpoint image”) may be obtained, and the image processing apparatus 102 may be configured to overlap the representation of the identifier with the plane viewpoint image. In this case, for example, the image processing apparatus 102 may be configured to change the object as the target to follow by the automatic maneuvering of the virtual viewpoint by selecting the representation of the identifier overlapped with the viewpoint image by the user by manipulating the manipulation unit 308.

In a case where the natural person corresponding to the three-dimensional shape associated with the already-selected identifier exits the image capturing region or enters the image capturing region while the automatic maneuvering of the virtual viewpoint based on the tracking information is performed, the positions indicated by the tracking information may be non-sequential. If the automatic maneuvering based on the tracking information is continued in the above-described case, the position or the orientation of the virtual viewpoint may be changed rapidly, and it may be difficult to view the virtual viewpoint image. To deal with this, for example, in a case where the position of the three-dimensional shape corresponding to the natural person as the processing target at the timecode as the processing target indicated by the tracking information is distant from the position concerned at the timecode immediately before for a predetermined distance or greater, the viewpoint obtainment unit 203 may stop the automatic maneuvering of the virtual viewpoint. Additionally, in a case where the reproduction speed of the virtual viewpoint image is increased to double-speed reproduction or the like while the image processing apparatus 102 performs the operation by the automatic maneuvering, the viewpoint obtainment unit 203 may perform the following processing. Specifically, in this case, for example, the viewpoint obtainment unit 203 increases a threshold, which is related to the above-described distance to judge whether the rapid change may occur in the position or the orientation of the virtual viewpoint, in proportion to the reproduction speed.

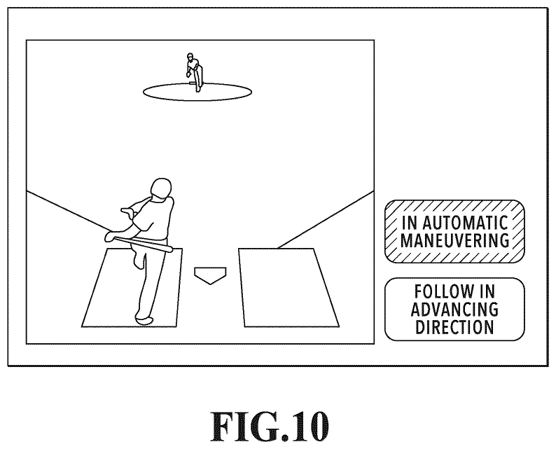

Additionally, the image processing apparatus 102 may present whether the image processing apparatus 102 is in a state of performing the operation by the automatic maneuvering of the virtual viewpoint to the user. FIG. 10 is a diagram illustrating an example of the display image displayed on the display apparatus 103 according to the first embodiment. As illustrated in FIG. 10 as an example, the user may easily figure out the state of the virtual viewpoint in the image processing apparatus 102 by expressing that the automatic maneuvering of the virtual viewpoint is being performed with highlighting and the like.

According to the image processing apparatus 102 formed as described above, a reduction in the estimation accuracy of the position of the object as the target due to the false shape generated according to a temporal change of the field surface may be suppressed.

### Modification of First Embodiment

In the first embodiment, an aspect in which the specification unit 205 uses the area in a case where the three-dimensional shape obtained by the estimation processing by the shape estimation unit 202 is projected onto the field surface and specifies the number of the three-dimensional shape corresponding to the natural person included in the three-dimensional shape concerned is described. However, the specification method of the number of the three-dimensional shape corresponding to the natural person is not limited thereto. For example, the number of the three-dimensional shape corresponding to the natural person may be specified by using the size of the three-dimensional shape such as the volume, the surface area, or the outer shape dimension of the three-dimensional shape obtained by the estimation processing by the shape estimation unit 202. In this case, as for an index of the size of the three-dimensional shape corresponding to one natural person, for example, the volume, the surface area, the outer shape dimension, or the like of a general adult that is described above in the first embodiment may be used.

Additionally, in the first embodiment, it is described that the data of the three-dimensional shape obtained by the estimation processing by the shape estimation unit 202 is stored in the auxiliary storage device 306 and the like, and the specification unit 205 performs the processing by reading out and obtaining the data of the three-dimensional shape from the auxiliary storage device 306 and the like. However, the obtainment method of the data of the three-dimensional shape by the specification unit 205 is not limited thereto. For example, the shape estimation unit 202 may store the data of the estimated three-dimensional shape into the auxiliary storage device 306 and the like and also transmit the data to the specification unit 205. In this case, the specification unit 205 may be configured to receive the three-dimensional shape data transmitted from the shape estimation unit 202 and sequentially perform the processing on the received three-dimensional shape data.

Moreover, in the first embodiment, an aspect in which the specification unit 205 changes the pixel value of the region corresponding to the false shape 610 in the height image to the pixel value corresponding to black color by performing the contraction processing on the height image so as to remove the false shape 610 as illustrated in FIG. 6A is described. However, the removement method of the false shape is not limited thereto. For example, the specification unit 205 may remove the false shape by performing the following processing. Specifically, for example, first, the specification unit 205 executes the region division processing (segmentation) on the effective region in the height image. Subsequently, the specification unit 205 judges that an area of the segment out of the divided multiple segments (independent region) that is equal to or smaller than a predetermined size, such as an area corresponding to 1000 pixels, is the false shape, and removes the false shape from the subsequent processing target.

Furthermore, although the baseball game is used as an example for the descriptions in the first embodiment, a scope of application of the technique of the present disclosure is not limited to the baseball game. For example, the technique of the present disclosure may be applied to image capturing in other sporting competition such as soccer game or road bicycle racing and may be applied to image capturing in dance performance and the like at a studio, a platform, a stage, and so on.

Additionally, in the first embodiment, an aspect in which the specification unit 205 changes the parameter related to the separation processing by the processing in S712 and executes again the processing in and after S701 by using the parameter related to the separation processing after change is described. However, the processing in a case where the number of the three-dimensional shape tabulated in S709 and the number of the three-dimensional shape corresponding to each natural person specified in S508 do not match is not limited to the processing of changing the parameter related to the separation processing. For example, in this case, the specification unit 205 may be configured to change the method itself of the separation processing by the specification unit 205. Specifically, for example, in the above-described case, the specification unit 205 changes the method of the separation processing by the specification unit 205 as described below. For example, first, the specification unit 205 performs processing of changing the value of the pixel (pixel value) with a low brightness in the changed height image to the pixel value corresponding to black color in S706. Subsequently, the specification unit 205 performs processing of removing a fine region generated due to the change concerned by contraction and expansion processing of the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-31409, filed Feb. 28, 2025, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining shape data indicating a three-dimensional shape of each object existing in a space as a target;
estimating, for each shape data, the number of three-dimensional shape corresponding to an object as a target included in the three-dimensional shape indicated by the shape data;
separating the three-dimensional shape corresponding to the object as the target, which is included in the three-dimensional shape indicated by the shape data, based on the estimated number and a height image indicating a height of a three-dimensional shape obtained by projecting the three-dimensional shape indicated by the shape data on a horizontal plane from the above; and
specifying a position of the separated three-dimensional shape corresponding to the object as the target.

2. The image processing apparatus according to claim 1, wherein the one or more programs further include instructions for estimating the number of the three-dimensional shape corresponding to the object as the target, which is included in the three-dimensional shape indicated by the shape data, based on at least one of a volume, a surface area, and an outer shape dimension of the three-dimensional shape indicated by the shape data and an area in a case where the three-dimensional shape indicated by the shape data is projected on the horizontal plane.

3. The image processing apparatus according to claim 1, wherein the one or more programs further include instructions for, in a case where the number of representation of the three-dimensional shape corresponding to the object as the target that may be included in an independent region in the height image is smaller than the estimated number, dividing the independent region concerned into a number of independent regions corresponding to the estimated number by deleting a region with a low brightness in the height image.

4. The image processing apparatus according to claim 1, wherein the one or more programs further include instructions for judging that an independent region in the height image that has a size equal to or smaller than a predetermined size does not include a representation of the three-dimensional shape corresponding to the object as the target.

5. The image processing apparatus according to claim 1, wherein the one or more programs further include instructions for:
obtaining virtual viewpoint information indicating a position of a virtual viewpoint and a line-of-sight direction in the virtual viewpoint; and
generating a virtual viewpoint image corresponding to a view from the virtual viewpoint based on the shape data and the virtual viewpoint information.

6. The image processing apparatus according to claim 1, wherein the one or more programs further include instructions for, based on a difference between specified positions of the three-dimensional shapes corresponding to the object as the target included in the three-dimensional shape indicated by the shape data corresponding to respective time points, specifying the three-dimensional shapes corresponding to the same object as the target, and generating tracking information in which the same identifier is associated with the three-dimensional shapes corresponding to the specified same object as the target.

7. The image processing apparatus according to claim 6, wherein the one or more programs further include instructions for:
obtaining virtual viewpoint information indicating a position of a virtual viewpoint and a line-of-sight direction in the virtual viewpoint;
generating a virtual viewpoint image corresponding to a view from the virtual viewpoint based on the shape data and the virtual viewpoint information; and
based on the tracking information, obtaining the virtual viewpoint information by determining the position of the virtual viewpoint and the line-of-sight direction in the virtual viewpoint such that a representation of the three-dimensional shape corresponding to the object as the target corresponding to a specific identifier is included in the virtual viewpoint image.

8. An image processing method comprising the steps of:
obtaining shape data indicating a three-dimensional shape of each object existing in a space as a target;
estimating, for each shape data, the number of three-dimensional shape corresponding to an object as a target included in the three-dimensional shape indicated by the shape data;
separating the three-dimensional shape corresponding to the object as the target, which is included in the three-dimensional shape indicated by the shape data, based on the estimated number and a height image indicating a height of a three-dimensional shape obtained by projecting the three-dimensional shape indicated by the shape data on a horizontal plane from the above; and
specifying a position of the separated three-dimensional shape corresponding to the object as the target.

9. A non-transitory computer readable storage medium storing a program for causing a computer to perform a control method of an image processing apparatus, the control method comprising the steps of:
obtaining shape data indicating a three-dimensional shape of each object existing in a space as a target;
estimating, for each shape data, the number of three-dimensional shape corresponding to an object as a target included in the three-dimensional shape indicated by the shape data;
separating the three-dimensional shape corresponding to the object as the target, which is included in the three-dimensional shape indicated by the shape data, based on the estimated number and a height image indicating a height of a three-dimensional shape obtained by projecting the three-dimensional shape indicated by the shape data on a horizontal plane from the above; and
specifying a position of the separated three-dimensional shape corresponding to the object as the target.
